(19) United States
(12) Patent Application Publication
(10) Pub. No.: US 2007/0038884 A1
(43) Pub. Date: Feb. 15, 2007

(54) System and method of remote storage of data using client software

(75) Inventors: Marc E. Campbell, Peoria, AZ (US); Cery Perle, Palm Desert, CA (US)

Correspondence Address: PILLSBURY WINTHROP SHAW PITTMAN LLP, P.O BOX 10500, McLean, VA, 22102, US

(73) Assignee: SPARE BACKUP, INC., Palm Desert, CA (US)

(21) Appl. No.: 11/475,308

(22) Filed: Jun. 27, 2006

Related U.S. Application Data
(60) Provisional application No. 60/707,471, filed on Aug. 10, 2005.

(51) Int. Cl. G06F 11/00

(52) U.S. Cl. 714/4

(57) ABSTRACT

Data, located on a client computer, is stored on a storage device in a computer located in a remote location. Backup software for the client computer loads into memory of the client computer. The backup scheduler and launcher software loads into memory, monitors an actual time at the client computer, compares the actual time to a scheduled backup time at the client computer, and launches a main backup software module of the backup software for the client computer if the actual time is equal to the scheduled backup time. A storage disk of the client computer is scanned to generate a backup list, the backup list including a plurality of files. The backup list is utilized to begin the storing of data located in the plurality of files onto the storage device of the computer at the remote location.

### RELATED APPLICATION DATA

This application claims priority to provisional application Ser. No. 60/707,471, filed Aug. 10, 2005.

### FIELD OF THE INVENTION

This invention relates generally to the backup of data from a client computer to a remote location and specifically to the automatic backing up of specified data from the client computer to an attached storage at a remote location.

### BACKGROUND OF THE INVENTION

In many corporate and enterprise environments, users utilize desktop computers, laptop computers, network computers, and other portable computers to connect to the network. The portable computers utilize many network resources during operation. In many cases, the portable computers are executing client - server applications where some of the executable software is located on the client and some the executable software is located on the server.

In many cases, the users transport the portable computer from home to the office, from one corporate location to another corporate location (e.g., when the user is a salesperson), or from home to a wireless hotspot. If the main storage unit, e.g., a hard drive or a removable drive, fails in the portable computer, the user can lose valuable data. Although users are instructed to back up their data on a regular basis, the complexity of the portable computer's operating system makes it difficult for the user to know exactly what to backup off their portable computer.

Also, computers have a wide variety of operating systems and application software. Even a user with excellent technical personal computer knowledge will have a difficult time knowing exactly what to backup from his computer.

In many corporations or organizations, a number of similar portable computers may be distributed to the individuals. The system administrator for the organization may wish to establish a backup policy for all individuals. However, it is difficult to have all the individuals to conform to the same backup policy or to backup the distributed portable computers. Thus, a high risk exists that data may be lost because the users did not abide by the organizational backup policy.

Accordingly, a need exists for a backup program that automatically backs up and stores data from the user's portable computer to a server.

### BRIEF DESCRIPTION OF THE DRAWINGS

The present invention is illustrated by way of example, not limitation, in the figures of the accompanying drawings, in which like references indicate similar elements and wherein:

FIG. 1 is a flow chart for the process of loading the client software onto a user system according to an embodiment of the invention;

FIGS. 2A-C are flow charts of the Online Backup Process according to an embodiment of the invention;

FIG. 3 is a flow chart of a process of Local Restore Media Spanning for restoring data according to an embodiment of the invention;

FIG. 4 is the System Architecture of the Spare Backup Client according to an embodiment of the invention;

FIG. 5 is a flow chart of the Spare Backup Service Scheduler Program according to an embodiment of the invention;

FIG. 6 is a flow chart of a backup process after installation of the software is complete according to an embodiment of the invention;

FIG. 7 is a flow chart of a backup process after initialization of the software according to an embodiment of the invention; and

FIG. 8 is a flow chart of interaction between a client backup software (the online backup software module) and a server in a remote location according to an embodiment of the invention.

### DETAILED DESCRIPTION

The present invention will now be described in detail with reference to the drawings, which are provided as illustrative examples of the invention so as to enable those skilled in the art to practice the invention. Notably, the implementation of certain elements of the present invention may be accomplished using software, hardware or any combination thereof, as would be apparent to those of ordinary skill in the art, and the Figures and examples below are not meant to limit the scope of the present invention. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

The present invention is directed to a software program installed on a portable or client computer that automatically backs up selected software on the portable or client computer. Under certain operating conditions, this may be referred to as a spare backup software program because the program is creating a spare backup of the contents of the client computer. The spare backup software program is performing an online backup of the contents of the client computer to a server located on a remote network. The online backup may be performed over a wireless network or over a wired network (such as a local area network or a wide area network). The spare backup software is automatically installed into memory of the client computer when the client computer is booted up, initialized, or re-initialized. The online backup module of the spare backup software program may be automatically scheduled to be executed during certain times of the day. The online backup module of the spare backup software program may be scheduled to be executed multiple times in a day. At the time of the execution of the scheduled online backup, the online backup module executes and backs selected information to the server system. Under certain operating conditions, the online backup is performed without any user intervention. Presets may be established in the spare backup software program to customize the information that is backed up during the automatic online backup process. The spare backup software program may include a main backup software module and a backup scheduler and launcher software module.

The client computer may be coupled to a server system via wired or wireless communication devices. The client computer may communicate with the server system via wired or wireless communication protocols. In an embodiment of the invention, the client computer and the server computer may be located on the same local area network. In an embodiment of the invention, the client computer may be remote from the server computer and may communicate over a wide area network or a global communication network, such as the Internet.

The client distribution is composed of three Windows executables and a plurality of dynamic link libraries (DLL). The client spare backup software includes three Windows executable files and a plurality of dynamic link libraries.

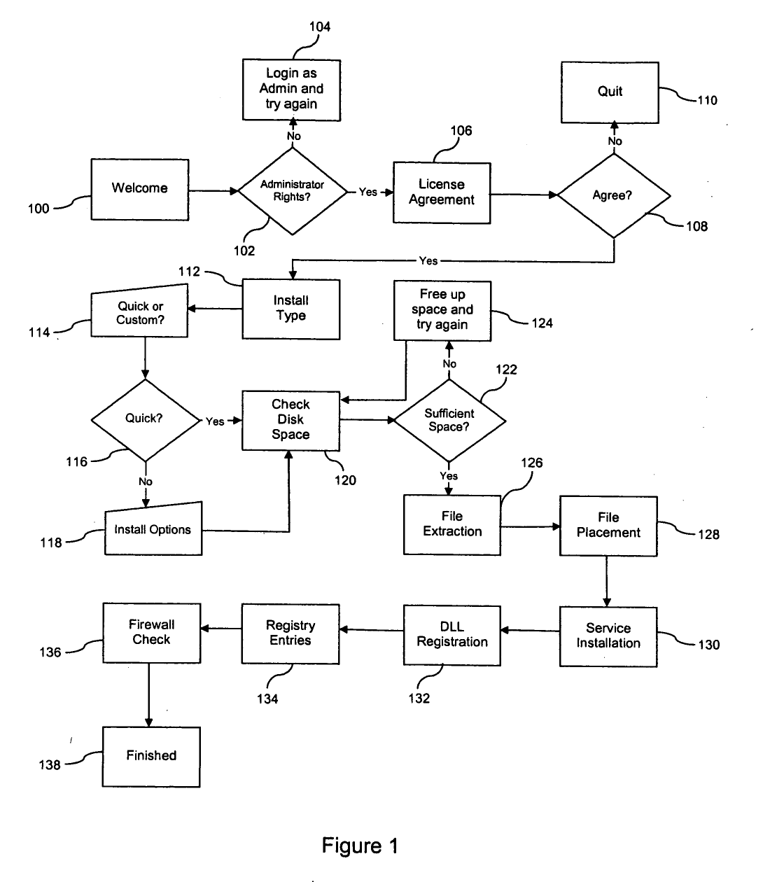

Referring now to FIG. 1, the process of installing client software on the user's system begins at step 100 with the welcome message. Although the process in discussed it is worth noting that the installation occurs one time for each user system that will be automatically backed up. For each user system or client device, the client software is automatically backed up one time. At step 102 it is determined if a user, with the necessary administrative rights, is logged onto the system to install software onto the system. If not, then at step 104 the user is prompted to log-off and log-in as a system administrator. If at step 102, the user has administrative rights, then at step 106 the client software license agreement is shown to the user to see if at step 108 the user agrees with the terms of the license agreement. If the user does not agree with or accept the license agreement, then at step 110 the process of installation is terminated. On the other hand, if the user accepts the license agreement, then at step 112 the user is prompted to select the type of installation, either custom or quick/standard. In an embodiment of the invention, checkboxes may be utilized to allow the user to determine whether or not to accept the license agreement. At step 114 the user selects the type of installation.

If, at step 116, the user selects quick installation, then at step 120 the client software checks the system disk space available for installing the client software. In an embodiment of the invention, if quick installation is selected, a default installation folder is utilized and a default program group is utilized. If the user selects to perform a custom installation, then the process proceeds to step 118 wherein the user is shown the various installation options. In an embodiment of the invention, the user can specify an installation folder. In an embodiment of the invention, the user can specify a program group. At step 122, it is determined if there is enough disk space for installing the client software. If not, then at step 124 the user needs to make disk space available and the process proceeds to step 120 to check disk space. In an embodiment of the invention, the setup folders may be created. If there is sufficient disk space available, then at step 126 the files are extracted to the created setup folders.

At step 128, the files are placed into the correct folders and/or dictionaries, as predetermined by the installation software. At step 130, the main backup software module and the backup scheduler and launcher software module may be installed. At step 132, the dynamic link libraries are installed onto the client computer. At step 134, the registry entries are made into the operating system, e.g., Microsoft Windows™ 95, 2000, XP operating system software, identifying the newly installed files as well as dynamically linked libraries. Under certain operating conditions, entries are made into the registry identifying that certain software programs are to be installed during the initialization or bootup process on the client computer. At step 136 the firewall is checked and the installation is completed at step 138. In addition to installation of the client software, the client software uninstaller is also loaded for future removal of the client software.

In an embodiment of the invention, if a Windows password is utilized to operate the system, then the user may be prompted to enter the Windows password. If the Windows password is entered, the setup or installer software validates the password, encrypts the password, and stores the password on the client computer.

In an embodiment of the invention, the installer program is an executable program and may be named, sparesetup.exe. In this embodiment of the invention, sparesetup.exe is a windows 32-bit executable software responsible for installing the client software on a client computer. The client computer may be a desktop computer, a laptop computer, a network computer, or any other type of computing device. The setup or installer program may be ,developed in Visual C++and may be statically linked to MFC. In an embodiment of the invention, the setup or installer program may be loaded onto a media and all of the required files may be stored on the media. Alternatively, the setup or installer program may be downloaded onto a computing device via a network (e.g., LAN, WAN, Internet).

After the installation has been complete, a plurality of files are installed in the client computer. In an embodiment of the invention, one of the files may be a main backup client module. This may be referred to as sparebackup.exe. The main backup client module may include a spare online dynamic link library, a spare local dynamic link library, and a spare scan dynamic link library. The main backup client module may also host web browser control. This may be Microsoft Internet Explorer Control. The main backup client module may also include the user interface software. In an embodiment of the invention, the user interface may be created in DHTML and Javascript. In an embodiment of the invention, the DHTML and Javascript files may be stored in a spare resources dynamic link library.

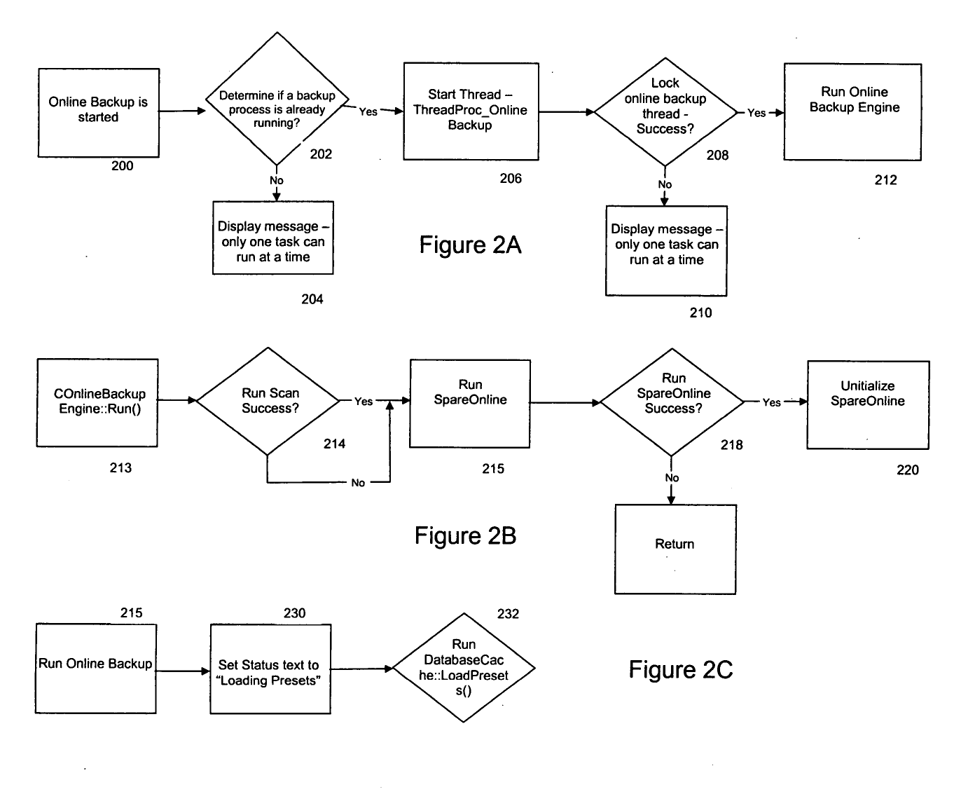

FIG. 2A illustrates a flowchart of an online backup process according to an embodiment of the invention. The online backup process is initialized 200. After the online backup process is initialized, it is determined 202 whether another online backup process is still executing. This may be referred to as determining whether an online backup checkin object can be entered. This may also be referred to as checking if a first instance of the online backup process has been initiated. If an online backup process is still executing (a first instance), a message is displayed 204. Illustratively, the message may state “only one task can run at a time.” If the process is running and the first instance is executing, then the online backup checkin object cannot be entered and this second instance is closed. The first online program is then run or executed. If there is no process running and the online backup checkin can be entered, an online backup process thread is started 206. After the online backup thread is started, it is determined whether the online backup checkin object can be locked 208. If the online backup checkin object cannot be locked, a message is displayed 210, such as “only one task can run at a time.” If the online backup checking can be locked, the online backup engine program is. run or executed 212.

FIG. 2B illustrates a flowchart of an online backup process according to an embodiment of the present invention. The online backup engine program is run or executed 213. After the online backup engine program is executed, the scanning program is run or executed 214. FIG. 2C illustrates a flowchart of a scanning process in the online backup process according to an embodiment the present invention. The scanning process is a search engine that is responsible for identifying all files, applications, and personal profiles (or personalities) installed on the computer and applying the preset filters to each of the files, applications, and personal profiles. After the online backup process program is executed 215, a status text message is displayed 230 to identify that present filters are being applied to all of the files, applications, and/or personal profiles installed on the computer. After the message is displayed, the online backup process program loads 232 the preset filters by executing, for example, a run load preset object. After the preset filters have been executed, the spare backup online module is executed 215 and the selected information from the client computer is backed up to the server system via a communications network, such as a local area network or the Internet. After the information is backed up, the spare backup software determines if the online backup was successful 218. If the online backup was not successful, the spare backup software reruns the process starting at step 213. If the online backup was successful, the online backup software module is unitialized (unloaded) 220.

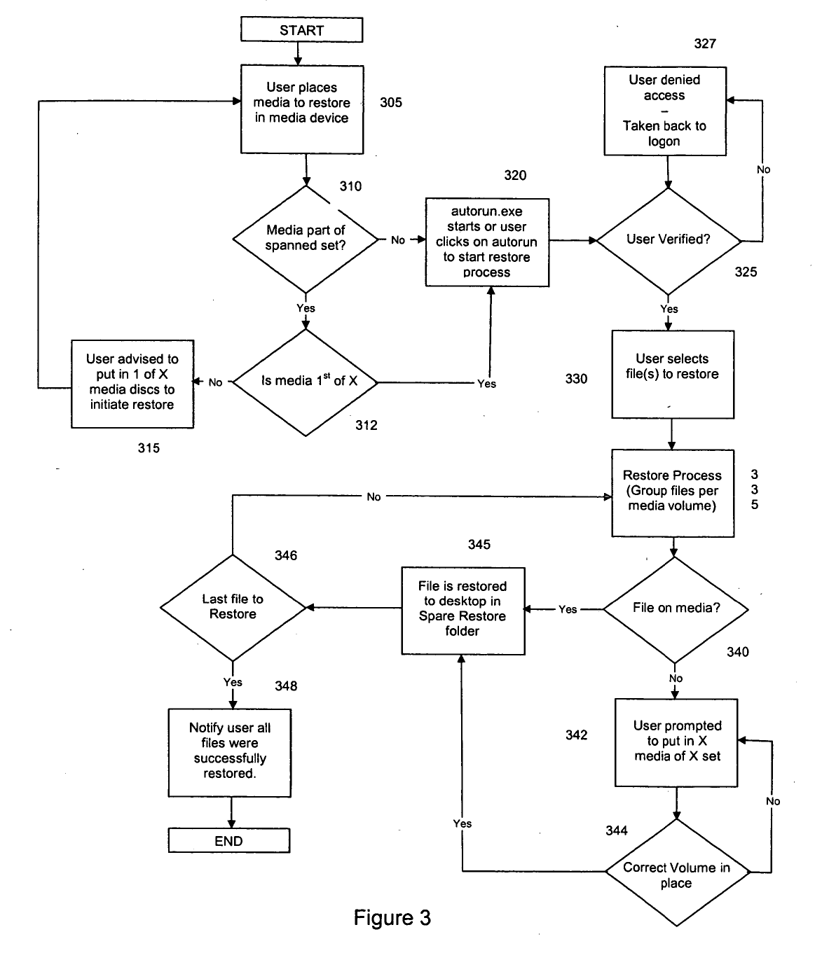

FIG. 3 illustrates a local restore media spanning according to an embodiment of the present invention. A user may place 305 the media to restore to in a media device, such as a CD/DVD/floppy drive/removable drive. During the restoration process, it is determined 310 whether the media is part of a spanned set, e.g., a number of media such as disks. If the media is part of a spanned set, then it is determined 312 whether the media is a 1^{st} of the number of media (e.g., disks). If the inserted media is not the 1^{st} of the number of media, then a request 315 is made to the user to put in the 1^{st} of the number of media. If the media is not part of a set or if the media is the 1^{st} disk of the set, then an autorun file initiates 320 the restore process.

The restore process then verifies 325 the user. If the user is denied access 327 because the user is not verified, the user is taken back to the logon screen. After the user is verified, the user can select 330 files to restore from the server system. After the files have been selected, the restore process is started 335. In an embodiment of the invention, the files are grouped per media volume. The restore process determines 340 if the file is on the inserted media. If the file is not on the inserted media, the user is prompted 342 to put in the media which includes the file, e.g., media or disk 3 of 5 disks. The user places 344 the correct volume into place. If the file is on the media or if the correct media is in place, then the file is restored 345 from the server system. In an embodiment of the invention, the file is restored into a spare restore folder on the client computer system. The restore process then determines 346 whether the restored file is the last file to restore. If it is not the last file to restore then the restore process is reinitialized. If it is the last file to restore, the user is notified 350 that all files are successfully restored.

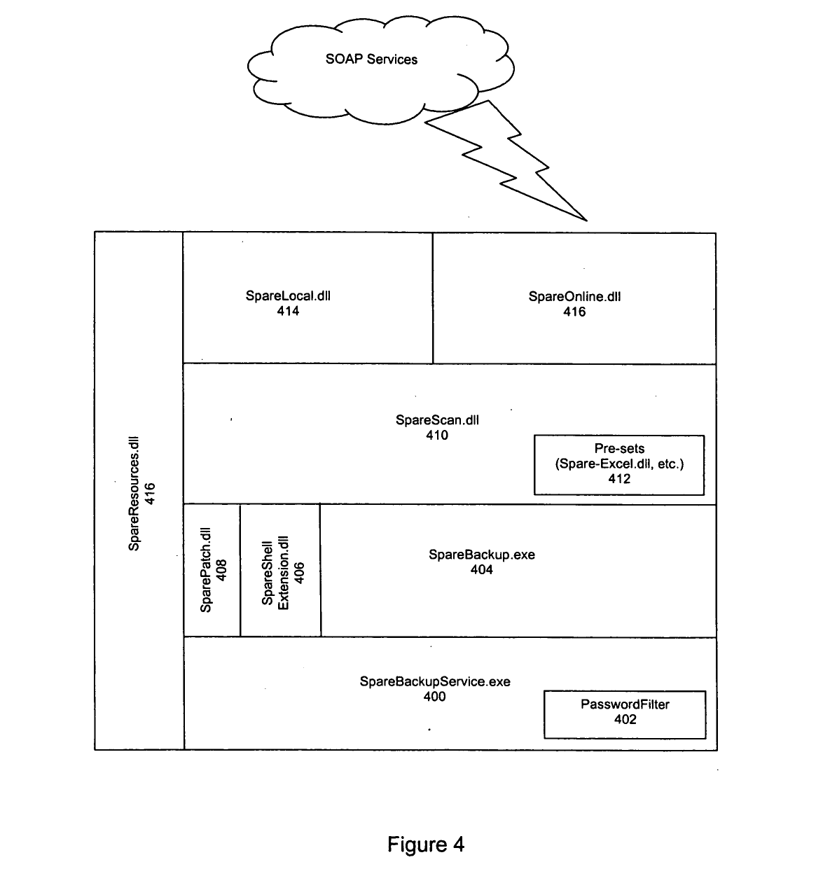

FIG. 4 illustrates a block diagram of the client backup software architecture according to an embodiment of the invention. The client backup software architecture includes backup software scheduler and launcher software module 400 (which may include a password filter 402 to allow the client software to retrieve the encrypted user log-on identity and password in order to allow the backup software scheduler and launcher to automatically log-onto the client computer and start the process of retrieving the data for remote storage on the server.). As noted above, the backup software scheduler and launcher 400 (e.g., the SpareBackupService.exe portion) may be running in the background to allow for the data storage services to be automatically provided. The main backup software module, (e.g., SpareBackup.exe portion) may include a plurality of dynamic link libraries 406, 408, 416 (e.g., sparepatch.dll, spareshellextension.dll, and spareresources.dll) to act as an interface between the user and the main backup software module 404.

In an embodiment of the invention, the scanning software module 410, which is the module that performs the scanning of the client computer to determine what files need to be scanned (e.g., SpareScan.dll) may include the preset information 412. The preset information 412 may identify which files do not need to be backed up. Under certain operating conditions, the preset information 412 may identify certain parameters or rules that the scanning software module is to apply. In an embodiment of the invention, a local backup library (e.g., the SpareLocal library 414) may include information and executables necessary for providing communication and data storage between the system and local devices, such as a CD-ROM or a server located on a local network. In an embodiment of the invention, the online scanning module 416 (e.g., the SpareOnline library) may include the information and executables necessary for communication and data storage between the user's system (the client computer) and the server located at a remote location, such as at a data storage facility.

FIG. 4 illustrates a system architecture of an online backup process according to an embodiment of the present invention. In an embodiment of the invention, the spare backup service program is loaded into RAM or operating memory of the client computer when the client computer is booted up or reinitialized, such as during a restart. The Spare. Backup Service program allows for automatic scheduling of the online backup process or program. In an embodiment of the invention, a system administrator can schedule running of the online backup process or program. For example, the system administrator can schedule a single backup or a plurality or number of client system backups. Alternatively, the client computer system may have an established backup schedule. In an embodiment of the invention, the spare backup service module monitors a time, which is kept by the client system. Once the spare backup service module determines the actual time-matches the scheduled time, the spare backup service launches or executes the spare backup module (e.g., spare₁₃backup.exe) to begin the actual online backup process. In an embodiment of the invention where the client computer system has password protection, the spare backup service module recovers the password, username, and/or domain name for the client computer system in order to launce the spare backup module.

The spare backup module is a primary means of interaction between a user and/or system administrator and the automatic online backup process. Illustratively, the spare backup module is a Windows™ 32-bit executable which includes a tray icon and a main menu. In an embodiment of the invention, the spare backup module may include or host the spare online module, the sparelocal module, and the sparescan module. The spare online module, the sparelocal module, and the sparescan module may be dynamic link libraries (.dll). In addition, the spare backup module also includes or hosts web browser control (e.g., MS Internet Explorer). The user interface may be created in DHMTL and Javascript. In an embodiment of the invention, the DHTML and Javascript files are stored in a spareresources module.

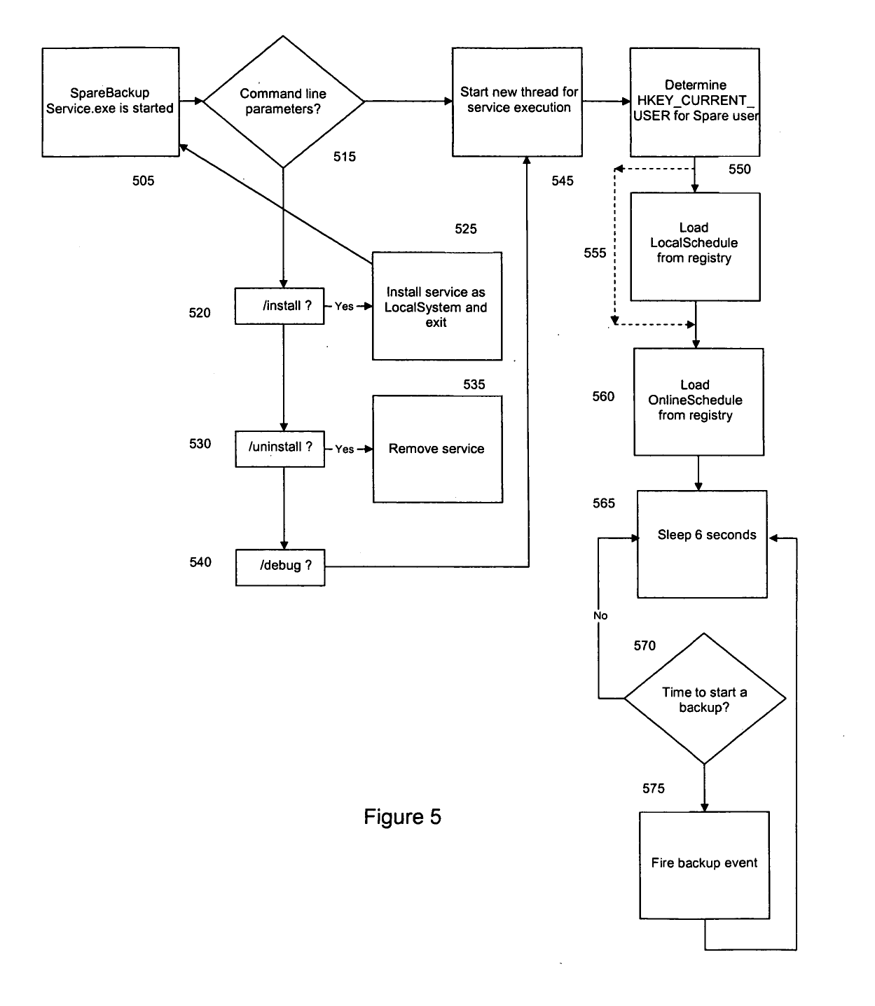

FIG. 5 illustrates a flowchart of the operation of the backup software scheduler and launcher software according to an embodiment of the invention. In the embodiment of the invention illustrated in FIG. 5, the backup scheduler and launcher is running 505. Under certain operating conditions, the backup scheduler and launcher is present in RAM and is running as long as the client computer is turned on. In the embodiment of the invention illustrated in FIG. 5, the backup software scheduler and launcher determines 515 if any command line parameters have been received. If an install command line parameter is received 520, e.g., “/install,” a new installation of the backup software scheduler and launcher is installed 525 on the client computer. After the installation is complete, the backup software scheduler and launcher is initiated and runs in RAM in the client computer. If an uninstall command line parameter is received 530, e.g., “/uninstall,” then the backup software scheduler and launcher is removed 535 from the client computer. In an embodiment of the invention, all of the software modules which make up the backup software are removed from the client computer. In an embodiment of the invention, if a debug command line parameter is received 540, e.g., “/debug,” the backup software scheduler and launcher is allowed to be accessed by the user who entered the debug parameter in order to debug or correct the backup software scheduler and launcher program.

If no command line parameters are received, a new thread for service execution is started. In other words, the backup software scheduler and launcher program is initiated or launched. Under certain operating conditions, an identification is determined 550 for the client computer or user. In an embodiment of the invention, the HKEY_CURRENT_USER is the identification for the user of the client computer.

In an embodiment of the invention, a local backup schedule may be loaded 555 from a storage location on the client computer. Some client computers may not include a local backup schedule. Under certain operating conditions, the storage location may be the registry in a Microsoft Windows™ operating system. A local backup schedule is utilized to backup specific content to media local to the client computer, such as a removable disk, a compact disk (CD), or a digital video disk (DVD).

In an embodiment of the invention, an online backup schedule may be loaded 560 from a storage location on the client computer. Under certain operating conditions, the storage location may be a registry in a Microsoft Windows™ operating system. The online backup schedule identifies a time (or times) when the online backup is scheduled to occur. In an embodiment of the invention, a default time is stored in the registry by the creator of the software. Under other operating conditions, a user or system administrator may be able to modify the time (or times) when the online backup is scheduled to occur.

The backup scheduler and launcher software then waits 565 a predetermined amount of time. In an embodiment of the invention, the predetermined amount of time may be six seconds, ten seconds, twelve seconds, or other amount of time. The backup scheduler and launcher software may then determine 570 whether or not a current time is the time of the scheduled backup. If the current time is not the time of the scheduled backup, the backup scheduler and software may return to the step of waiting a predetermined time (e.g., step 565). Under certain operating conditions, the predetermined time may be the same time in the first iteration. Under other operating conditions, the predetermined time may be a different time as in the first iteration.

If the current time is the time of the scheduled online backup, then a backup event is fired or initiated 575. In other words, the online backup software module is initiated and the backup of the specified files on the client computer is completed. After the online backup software module is initiated and completed, the backup scheduler and launcher module returns to waiting the predetermined amount of time, e.g., step 575.

In an embodiment of invention, a user can edit the backup software scheduler and launcher software module. Under certain operating conditions, the user can change the time of the launch of the backup software to any timeframe when the user may not be utilizing the computer, e.g., lunch hour—12:00- 1:00 pm or early morning (any time between 1:00am - 4:00 am). The user can also modify how many times the backup software scheduler can run in a single day. If a client computer is utilized extensively and has important or mission critical information stored on the client, a user or system administrator may desire to backup the client computer two or more times a day. Initially, the backup software scheduler and launcher has a default time established for the launching of the scanning and subsequent backing up of the client computer. The user may enter the main interface screen of the backup software (e.g., within the main backup software module) in order to modify or schedule the launching of the scanning and subsequent backing up of the client computer. Under certain operating conditions, a user or a system administrator can also select an action which the client computer is to perform. For example, the user can select that the client computer is turned off after the online backup is complete. Illustratively, the user can also select that the client computer is returned to an original screen after the online backup is complete. Alternatively, the main backup software module may return to the screen the client computer was on when the backup scheduler or launcher originally initiated the backing up of the backup list of the client computer.

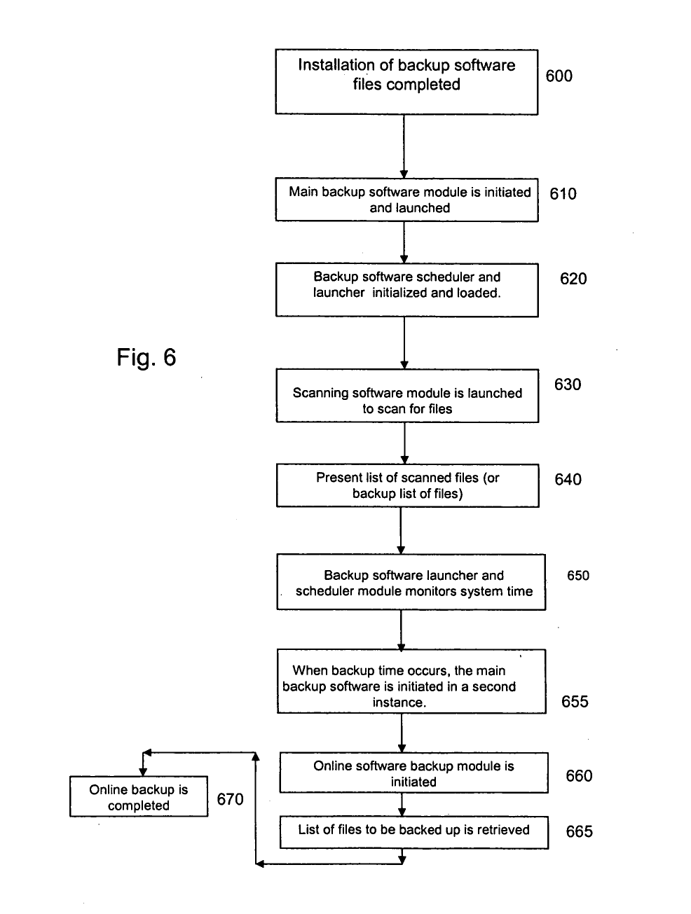

FIG. 6 illustrates a method of operation of a client backup software system according to an embodiment of the present invention. In an embodiment of the invention, installation of the software is completed 600. After installation is completed, the main backup client software module is automatically initiated 610 and loaded into memory of the client computer. In an embodiment of the invention, the backup software scheduler / launch module is automatically initiated 620 and loaded into the memory of the client computer.

In an embodiment of the invention, a scanning software module is automatically started 630. This may be referred to as the initial scan of the client computer. This may occur by a calling of the scanning software module. The scanning software module scans a storage media of the client computer, e.g., a hard disk, a flash drive, a floppy drive, etc., to determine files located or stored on the client computer. In an embodiment of the invention, the scanning software module may be a dynamically linked library that is called by the main backup client software module. The scanning software module compiles a list of files that are located on the storage media of the client computer. This may be referred to as a backup list. In an embodiment of the invention, the backup list of files is stored in a file on the client computer. In an embodiment of the invention, the backup list of files is stored in a file in memory of the client computer. The scanning software module includes logic or computer-readable instructions which identify how specific programs on the client computer should be backed up. Illustratively, the logic may identify how to back up Microsoft Outlook™ files, Microsoft Word™ files, Microsoft PowerPoint™ files, Adobe Acrobat™ files, etc. Illustratively, the logic may identify how to back up files in any application program. In other words, the scanning software module is identifying files on the client computer that the backup software will utilize and store onto a remote computer, such as the remote server.

In an embodiment of the invention, a list of files (the backup list) may be displayed 640. Under certain operating conditions, a user may change (add or delete files) to the list of files. In an embodiment of the invention, if the client computer is running a Microsoft Windows™ operating system, the list of files may be stored to a registry of the Microsoft Windows™ operating system. The main backup software module is now ready to backup contents of the client computer.

FIG. 6 continues to illustrate the backup operation if a client computer is left operational after the initial scan of the client computer has been completed by the scanning software module. As noted above, a preset scheduled time has been established for backup of the files of the client computer. Under certain operating conditions, the preset scheduled time is 8:00 p.m. local time for the client computer. As noted above, the backup software scheduler and launcher software module has already been loaded into the memory of the client computer. The backup software scheduler and launcher module is monitoring the system time (or system clock) to determine 650 if the system time matches or is close to the preset backup scheduled time. Once the system time matches the preset time, the backup software scheduler launches 655 the main software backup module.

Under certain operating conditions, the main backup software module is already launched. In other words, a first instance of the main backup software module is already running. If the first instance of the main backup software is already loaded or launched, the second instance of launching, e.g., step 655, may be terminated. Before the termination of the second instance of the main backup software module, a message is transmitted to the first instance of the main backup software launching to start the online backup.

In an embodiment of the invention, the online backup software module is initiated 660. The online backup software module interacts with the server to transfer contents of the list of files to a storage on the backup server. In other words, this performs the actual backing up of the list of files for the client computer specified in the backup list. Under certain operating conditions, the online backup software module retrieves 665 the list of files to be backed up and transmits this list of files to the backup server. Under certain operating conditions, the backup list of files may be stored on the client computer. Under certain operating conditions, the backup list of files may be stored on the server or another remote computing device. The backup server operates to upload all of the files that are specified in the list of files. The detailed operation of the backup server is disclosed in corresponding provisional patent application 60/______ filed Aug. 10, 2005, entitled Spare Backup Server, which is incorporated herein by reference.

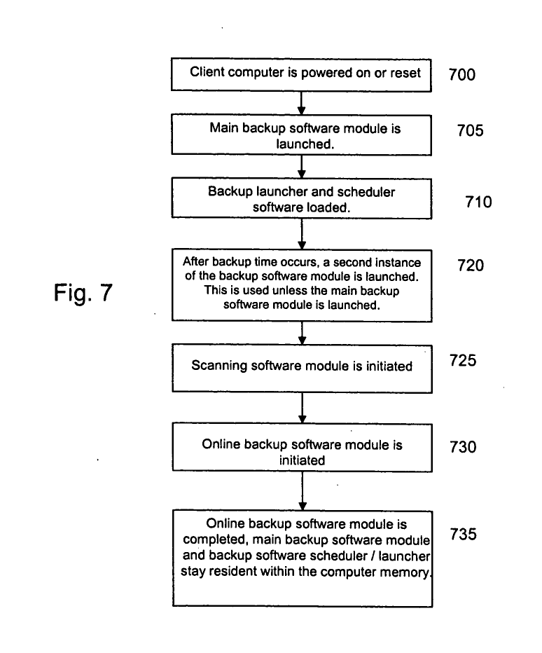

The online backup server module completes 670 the backup of the contents of the backup list of files. A detailed discussion of the interaction between the client and server is provided below. The online backup server module receives a completion notification from the server. After the completion notification, if the client computer is not logged off or does not log itself off, the client computer goes back to a waiting state until the scheduled backup time occurs again. In other words, under certain operating conditions, the main backup software module and the automatic scheduler/launcher module may stay resident or stay loaded in memory of the client computer. FIG. 7 illustrates a method of operating the spare backup system during initialization of a client computing device according to an embodiment of the present invention. This operation has some steps in common with the embodiment of the invention illustrated in FIG. 6. In this embodiment of the invention, a client computer is powered-on 700 or a hardware reset has occurred. After boot-up of the client computer, the main backup software module is loaded 705 into a memory of the client computer. In addition, after boot-up of the client computer, the backup scheduler and launcher software module is loaded 710 into the memory of the client computer. In an embodiment of the invention, the scanning software module is loaded and a scan is completed to obtain a list of files that have changed since the last scan had been completed. The programs stay resident in the memory during operation of other programs. Because the backup scheduler and launcher program has already been loaded with a time for backup, either with a default time (such as 8 p.m.) or has been modified by the system administrator or user, the program may stay resident and non-operational until the scheduled time for backup. Once the scheduled backup time has occurred, the backup schedule and launcher initializes and launches 720 an instance of the main backup software module. The main backup software module launches or initializes 725 the scanning software module. Under certain operating conditions, the scanning software module scans the disk of the client computer for files that have changed since the original scan or last scan was performed. Under other operating conditions, the scanning software module scans the disk of the client computer and identifies all of the files that are located on the client computer which need to be backed up. The user or system administrator can also establish a list of what files the scanning module identifies need to be scanned. In an embodiment of the invention, presets can then be utilized to change which files are backed up. In an embodiment of the invention, the user can modify the scanning software module through the use of presets (which are described later), to identify that certain files are not to be backed up even though the files exist on the disk.

After the scanning software module has generated a list of files (which may be referred to as a list of files), the online backup software module is launched 730 and a backup of the backup list of files is performed. In an embodiment of the invention, all of the files listed in the generated list of files are backed up and stored on a server. In an embodiment of the invention, only the files that have been modified since the last backup was performed are backed up and then stored on the server. After the online backup software module has completed 735, the backup software main module and the backup software scheduler/launcher module stay resident in the memory.

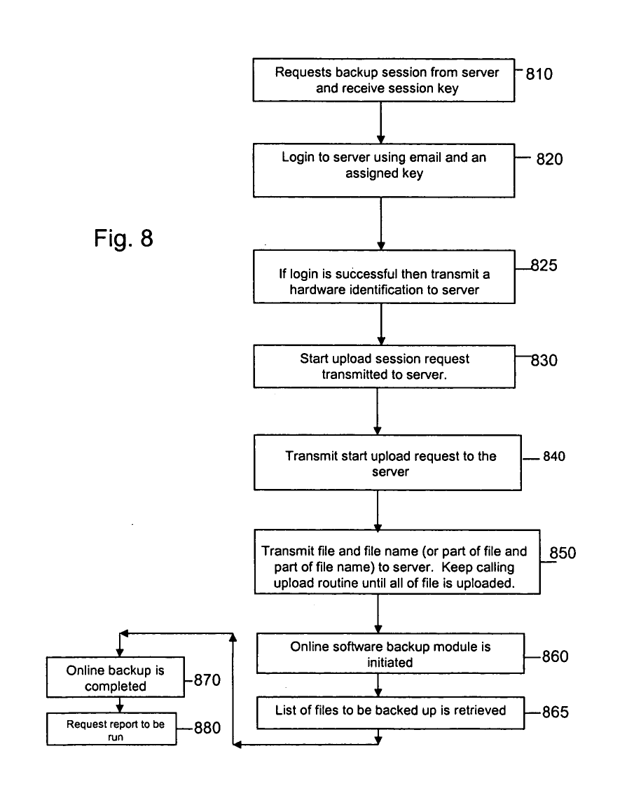

FIG. 8 illustrates the interaction of the online backup software module with the server according to an embodiment of the present invention. In other words, FIG. 8 describes the operation of step 730 of FIG. 7. In an embodiment of the invention, the online backup software module requests 810 a session from the backup software module on the server. Under certain operating conditions, the online backup software module may call a request session module (or routine). The server may assign the online backups software module (or client) a session key which is utilized to encrypt / decrypt the messages for the remainder of the session.

The online backup software module may login 820 to the server utilizing an email and an assigned key (which is different than the session key). The server may query a database housing user account information to verify that the user is an authentic user. If the login is successful, the online backup software module may send 825 a hardware identification to the server and the server may verify that the hardware identification for the client computer is authentic.

In an embodiment of the invention, the online backup module may send 830 a start upload session request. This may occur by calling a start upload session routine. The server receives the start upload session request and communicates with the database so that the database can update a history log identifying that an upload session is about to begin. If a previous upload was incomplete, the server would send back a file identification and a part count to the client computer in case the client computer wanted to resume the backup in the same place where the upload was incomplete.

In an embodiment of the invention, after the start upload session has occurred, the online backup software module may transmit 840 a start upload command (e.g., by calling the start upload routine) for a specific file. Under certain operating conditions, with the start upload command, the online backup software module may send a file name, a file directory, a file hash, and an original file size to the computer. The server may receive this information and may query the database to determine if the information in the database for the file is the same as the file that is to be uploaded. If the file and the file information in the database are the same, then this file is skipped, and the online backup software module moves to backing up the next file in the list of files (e.g., the backup list created by scanning software module). If there is no existing file information in the database or if the file has different information as compared to the file information in the database, then the server enters information into the database regarding the file to be uploaded. Illustratively, if there is no information, the server enters in the relevant information to the database, such as file name, file location, maybe file size, etc.. The server then sends a new file identification to the client, e.g., the online backup software module, to assist in uploading the file. Illustratively, if there is information, but the stored information is different from the transmitted information, then the file information for the file is updated in the database.

In an embodiment of the invention, if the file is to be uploaded, the online backup software module may send 850 the file name and the file (or a part of the file and the part of the file name) to the server. This may be accomplished by the online backup software module calling the upload routine. The server may receive the file (or part of the file) and may store the file (or the part of the file) to an upload folder. In an embodiment of he invention, the file may have been divided into file parts (due to the size of the file). If the file has been divided into file parts, then the online backup software module may continue to send the file parts (and the name of the file parts) to the server until the entire file has been uploaded to the server and then stored into the upload folder on the attached storage. Under these operating conditions, the online backup software module continues to call the upload routine. Under certain operating conditions, the server communicates to the online backup software module that each file part has been successfully uploaded. After the file has been uploaded, the file may be moved from the upload folder to the user's folder on the attached storage.

After the file has been uploaded (i.e., all the parts have been uploaded), the online backup software module may transmit 860 the file identification and a preset list to the server. If the file has been broken up into file parts, then the server receives the file identification and preset information and utilizes this information to merge the file parts into the original compressed and encrypted file. The server then moves the merged file from the upload folder to the user's folder on the attached storage. In an embodiment of the invention, after the file has been moved to the user's folder, the database is updated by associating presets with the uploaded file and updating information about the uploaded file in the database. In an embodiment of the invention, new files are flagged for virus scan checking and also for optimization. After this has occurred, the server sends a message to the online backup software module that the upload of the file is completed. Steps 840 (may be referred to as start upload), 850 (may be referred to as upload), and 860 (may be referred to as finish upload) are called for each file that needs to be uploaded by the online backup software module. In an embodiment of the invention, if all of the files to be uploaded are smaller than a threshold size, then a quick upload function may be called, which does not require the sending of files in parts and the reconstructing of the files at the server.

After all of the files have been uploaded, the online backup software module may transmit 870 a finish upload session command (e.g., may be referred to as a finish upload session routine). The server updates the database after receiving the finish upload session command and sends the online backup software routine a confirmation that the database has been updated.

After the confirmation is received that the upload session is finished, the online backup software module may request 880 that a backup report be compiled and transmitted to the online backup software module (and the client computer). Under certain operating conditions, the online backup software module may send a file count, a skipped file count, and a list of file IDs for the skipped files. The server generates a request for the backup report to a server responsible for generating reports. The report is generated and later sent to the client computer (e.g., via the online backup software module).

In an embodiment of the invention, presets can be utilized to identify certain parts files to be backed up or to customize certain areas of the software. Under certain operating conditions, after the main backup software module is loaded, a preset software module is loaded and initialized. Under certain operating conditions, the main backup software module is loaded before the scanning module is initialized of loaded. After the main backup software module has completed the backup, the preset software module is uninitialized or unloaded. In an embodiment of the invention, this may occur after the online scanning module has completed its operation. In an embodiment of the invention, the main backup software module is normally preset to perform a full scan when the scanning software is launched. Under certain operating conditions, a preset file may be loaded that requests that a quick scan be performed.

Below is listed a general bullet-point description of dataflows in the operations of installing and deinstalling the main backup software module.
1. [Installing Spare Backup]
   a. Service Installation (Local System)
   b. Dynamic Link Library Registration
   c. Registry Entries
      Software is installed for use by the current user only. Other users on the client computer do not have access to Spare Backup.
      i. Run
      ii. Program Group
      iii. Uninstall
2. Finished

Uninstaller
1. Original (no parameters)
   a. Executed by user or Windows Add/Remove programs
   b. [Hidden] - Not accessible to general users.
   c. Replicates to Temp directory
   d. Executes replica in Temp directory, passing parameter “/uninstall”
   e. Self-Terminates
2. Replica (with parameter)
   a. Executed by Original with parameter “/uninstall”
   b. [Confirmation]
   c. Privilege Check (user must have Administrator rights)
   d. [Stopping Spare Backup]
      i. Stops Spare Scheduler
      ii. Closes any instances of Spare Backup
   e. [Uninstalling Spare Backup]
   f. Unregisters DLLs
   g. Removes Service
   h. Removes Files
   i. Removes Registry Entries
   j. Updates Registry for self removal on next Startup
   k. [Restart Windows]
      i. Restarts Windows
      ii. Self Terminate

Descriptions are provided below of illustrative modules within the spare backup client software program.

SpareBackup.exe (e.g., the Main Backup Software Module)

This is a Windows 32-bit Executable which is the primary means of interaction between the user and the software. This includes the tray icon and the “main menu”.

The main backup software module hosts a number of other software modules (SpareOnline.dll, SpareLocal.dll, SpareScan.dll, etc).

The main backup software module may also host WebBrowser (MSIE) control. Under certain operating conditions, the user interface is created in DHTML and Javascript. All of the HTML/JS files may be stored in SpareResources.dll.

SpareBackupService.exe (e.g., the Backup Scheduler and Launcher Software Module).

In an embodiment of the invention, the backup scheduler and launcher software module is a Windows service, running as Local System on the client computer, and is responsible for scheduling and launching the automatic backups. In an embodiment of the invention, the backup scheduler and launcher software module recovers the usemame/password/domain name that was encrypted during setup and logs into the computer as this user.

SpareScan.dll (e.g., the Scanning Software Module)

The scanning software module may be the Spare Backup (or client backup software) search engine. The scanning software module is responsible for identifying all files, applications, and personalities installed on the computer and applying the preset filters to each of the files, applications, and personalities. Under certain operating conditions, the scanning software module may dynamically locate, load, run, and unload each of the Preset dll files.

Preset files and modules are listed below. Illustratively, Spare-Excel.dll, Spare-InternetExplorer.dll, etc. may identify how and which of the files in the program are to be stored from these applications. The DLLs all export the same functions on the same ordinals:
i Preset_Initialize_loads preset module into memory
ii Preset_Uninitialize_unloads present module from memory
iii Preset_DoFullScan_If this preset is loaded, the scanning module runs a full scan. The scanning module scans the entire file system and registry for pre-defined files and settings to back up.
iv. Preset_DoQuickScan_If this preset is loaded, the scanning module runs a quick scan, where only a number of specified files are loaded.
v. Preset—ExportToFile_This module exports the output of a preset to a file. This may be used when creating the initial scan report
vi. Preset_Run_This is a function called when the preset module is executed.
vii. Preset_GetName_When called, this returns the name of the preset.
viii. Preset—GetDescription_When called, this returns the description of the preset
ix. Preset_GetGUID_When called, this returns the globally unique identifier (GUID) of this preset.

SpareOnline.dll (e.g., the Online Backup Software Module).

This module performs the actual backup of the files from the client computer. This is the only method of communication from the client to the server. The client main backup software uses SOAP and DIME by implementing the open source, freely licensed GSoap software. FIG. 8 illustrates the operation of the online backup software module.

SpareLocal.dll

FIG. 3 illustrates the local backup of the client computer, e.g., to a CD, DVD, or a removable disk. This is how local (manual). backups and restores are processed.

SparePatch.dll_Updating the Main Backup Software

Executed by Spare Backup when a patch has been made available
a. [Downloading Update]
   i. Connects to download.sparebackup.com via HTTP
   ii. Requests patch via GET command
   iii. Saves patch to disk
b. [Stopping Spare Backup]
   i. Stops Spare Scheduler
   ii. Closes any instances of Spare Backup
C. [Applying Update]
   i. Applies patch
d. [Update Successful]
e. [Restarting Spare Backup]
   i. Restarts Spare Scheduler
   ii. Restarts Spare Backup
f. Self Terminates

SparePasswordFilter.dll (e.g., the Password Filter)

The password filter may be loaded by the Windows operating system and may monitor for password changes. When the user changes the Windows password, the password filter may update the encrypted, stored password for utilization during the backing up of the client computer.

Setup Process

This provides a general illustration of the setting up of the client backup software.
1. The files may be located in a Distribution folder and New folder are compiled into Windows 32-bit Executable
a. “SpareSetup.exe” is created in Distribution folder
2. SpareSetup.exe is uploaded to download.sparebackup.com via FTP
3. Database is updated

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated.

What is claimed is:

1. Method for storing data at a remote location using a client resident on a local machine, the method comprising the steps of:
initiating a communication session between a remote location and a client system;
authenticating the client on the local machine using identity and password information; and
storing data from the client at the remote location.

2. A system for storing data at a remote location, comprising:
means for initiating a communication session between a remote location and a client system;
means for authenticating the client on the local machine using identity and password information; and
means for storing data from the client at the remote location.

3. A system for storing data at a remote location, comprising:
a server system including a database for storing configuration information and an attached storage for storing files of users; and
a client computer, the client computer including:
a storage disk to store a plurality of files;
a scanning module to scan the storage disk and generate a list of files of the plurality of files to be backed up to the server system; and
an online backup module to utilize the list of one or more files and to backup data corresponding to the list of one or more files from the client computer to the server system.

4. The system of claim 3, further including a preset module to filter the list of one or more files that is generated by the scanning module.

5. The system of claim 3, further including a backup scheduling and launching module to verify that an actual time matches a backup scheduled time and to initiate the scanning module in order to generate the list of one ore more files.

6. The system of claim 5, wherein the backup scheduling and launching module is loaded into a memory of the client computer after initialization of the client computer.

7. The system of claim 5, wherein the backup scheduling and launching module utilizes a password filter to login into the client computer in order to the launch the scanning module.

8. The system of claim 3, wherein the online backup module divides up the data in the list of more than one file into parts in order to speed up the backup process.

9. The system of claim 3, wherein the online backup module utilizes SOAP services to communicate with the server system.

10. A method for storing, at a remote location, data that is presently stored on a client computer, the method comprising:
loading an online transmitting a request to a computing device at the remote location to begin a backup of a plurality of files stored on a storage disk of the client computer;
receiving authorization to begin backup of the plurality of files stored on the client computer;
scanning the storage disk to generate a backup list of the plurality of files that are to be stored at the computing device at the remote location;
backing up the plurality of files identified in the backup list from the client computer to the computing device at the remote location;
receiving a message at the client computer identifying each of the plurality of files that have been successfully stored on the computing device at the remote location; and
completing the storing of the plurality of files on the computing device at the remote location by receiving a completion message from the computing device at the remote location and by unloading the online backup software module at the client computer.

11. The method of storing data of claim 10, wherein during the backing up of the plurality of files, certain files of the plurality of files are divided up into file parts so as to accelerate the backing up of the plurality of files.

12. The method of storing data of claim 10, wherein before the scanning the storage disk, a preset module is loaded to identify one or more files on the storage disk that are not to be placed in the generated backup list.

13. The method of storing data of claim 10, wherein before the transmitting step, a backup scheduler and launcher module monitors a system time, compares the system time to a scheduled backup time, and initiates the transmitting step if the system time is the same or later than the scheduled backup time.

14. The method of storing data of claim 13, further including retrieving a password from a storage area on the client computer and utilizing the password to login to the client computer before the transmitting step.

15. The method of storing data of claim 10, further including receiving a report identifying stored files on the computing device at the remote location.

16. The method of storing data of claim 10, wherein the backing up of the plurality of files includes transmitting each file of the plurality of files and a name for each file to the computing device at the remote location to determine whether or not each file can be skipped during the backing up of each file of the plurality of files.

17. A method for storing data, located on a client computer, to a storage device in a computer located in a remote location, comprising:
initializing the client computer;
loading backup software for the client computer into a memory of the client computer;
loading a backup scheduler and launcher software into the memory of the client computer;
monitoring an actual time at the client computer;
comparing the actual time to a scheduled backup time at the client computer;
launching a main backup software module of the backup software for the client computer if the actual time is equal to or later than the scheduled backup time;
loading a preset file into the memory of the client computer to establish rules as to which files are to be stored on the storage device of the computer in the remote location;
scanning a storage disk of the client computer to generate a backup list, the backup list including a plurality of files, wherein the preset file is utilized to determine which of the files on the client computer are to be included in the backup list; and
utilizing the backup list to begin the storing of data located in the plurality of files onto the storage device of the computer at the remote location.

18. The method of claim 17, wherein the storing of data includes storing the plurality of files one at a time at the storage device of the computer at the remote location until all of the plurality of files are stored, wherein at least one of the plurality of files is skipped because a copy of the file already existed at the storage device of the computer.

19. The method of claim 18, wherein if a size of one of the plurality of files is greater than a predetermined size, the one of the plurality of files is divided into file parts to improve speed for storing the data.

20. The method of claim 18, wherein the software scheduler and launcher utilizes a password filter to enter a password into the client computer in order to launch the main backup software module if the client computer is password protected.
